(19) United States
(12) Patent Application Publication
(10) Pub. No.: US 2008/0203196 A1
(43) Pub. Date: Aug. 28, 2008

(54) Nozzle Arrangements

(75) Inventors: Keith Laidler, West Midlands (GB); Rajab Sharief, Manchester (GB); Hassan Abduljalil, Manchester (GB)

Correspondence Address: PEARSON & PEARSON, LLP, 10 GEORGE STREET, LOWELL, MA, 01852, US

(73) Assignee: INCRO LIMITED, West Midland (GB)

(21) Appl. No.: 10/562,801

(22) PCT Filed: Jul. 2, 2004
(86) PCT No.: PCT/GB2004/002848

§ 371 Date: Apr. 10, 2008

(30) Foreign Application Priority Data
Jul. 4, 2003 (GB) 0315664.3

(51) Int. Cl. B05B 1/14

(52) U.S. Cl. 239/553.5; 239/548

(57) ABSTRACT

A nozzle arrangement includes a chamber (204) having a plurality of divergent inlet orifices (203) which are directed towards opposed walls (205) or sidewalls (206) of the chamber (204). The chamber (204) is further provided with a plurality of outlet orifices (102) which are not aligned with the inlet orifices (203) and in the preferred embodiment also constitute outlet orifices of the nozzle arrangement

The present invention relates to nozzle arrangements. More particularly, but not exclusively, the present invention relates to nozzle arrangements that are adapted to generate a spray of a fluid, which is forced to flow through the nozzle arrangement under pressure.

Nozzles are often used to provide a means of generating sprays of various fluids. In particular, nozzles are commonly fitted to the outlet valves of pressurised fluid-filled containers, such as so-called “aerosol canisters”, to provide a means by the fluid stored in the container can be dispensed in the form of a spray or mist. A large number of commercial products are presented to consumers in this form, including, for example, antiperspirant sprays, deodorant sprays, perfumes, air fresheners, antiseptics, paints, insecticides, polish, hair care products, pharmaceuticals, water and lubricants. In addition, pump or trigger-actuated nozzle arrangements, i.e. arrangements where the release of fluid from a non-pressurised container is actuated by the operation of a manually operable pump or trigger that forms an integral part of the arrangement, are also frequently used to generate a spray or mist of certain fluid products. Examples of products that typically incorporate pump or trigger nozzle devices include various lotions, insecticides, as well as various garden and household sprays.

A spray is generated when a fluid is caused to flow through a nozzle arrangement under pressure. To achieve this effect, the nozzle arrangement is configured to cause the fluid stream passing through the nozzle to break up or “atomise” into numerous droplets, which are then ejected through an outlet of the arrangement in the form of a spray or mist.

The optimum size of the droplets required in a particular spray depends primarily on the particular product concerned and the application for which it is intended. For example, a pharmaceutical spray that contains a drug intended to be inhaled by a patient (e.g. an asthmatic patient) usually requires very small droplets, which can penetrate deep into the lungs. In contrast, a polish spray preferably comprises spray droplets with larger diameters to promote the impaction of the aerosol droplets on the surface that is to be polished and, particularly if the spray is toxic, to reduce the extent of inhalation.

The size of the aerosol droplets produced by such conventional nozzle arrangements is dictated by a number of factors, including the dimensions of the outlet orifice and the pressure with which the fluid is forced through the nozzle. However, problems can arise if it is desired to produce a spray that comprises small droplets with narrow droplet size distributions, particularly at low pressures. The use of low pressures for generating sprays is becoming increasingly desirable because it enables low pressure nozzle devices, such as the manually-operable pump or trigger sprays, to be used instead of more expensive pressurised containers and, in the case of the pressurised fluid-filled containers, it enables the quantity of propellant present in the spray to be reduced, or alternative propellants which typically produce lower pressures (e.g. compressed gas) to be used. The desire to reduce the level of propellant used in aerosol canisters is a topical issue at the moment and is likely to become more important in the future due to legislation planned in certain countries, which proposes to impose restrictions on the amount of propellant that can be used in hand-held aerosol canisters. The reduction in the level of propellant causes a reduction in the pressure available to drive the fluid through the nozzle arrangement and also results in less propellant being present in the mixture to assist with the droplet break up. Therefore, there is a requirement for a nozzle arrangement that is capable of producing an aerosol spray composed of suitably small droplets at low pressures.

A further problem with known pressurised aerosol canisters fitted with conventional nozzle arrangements is that the size of the aerosol droplets generated tends to increase during the lifetime of the aerosol canister, particularly towards the end of the canisters life as the pressure within the canister reduces as the propellant becomes gradually depleted. This reduction in pressure causes an observable increase in the size of the aerosol droplets generated and thus, the quality of the spray produced is compromised.

Accordingly, it is an object of the present invention to provide a nozzle arrangement that is adapted to generally reduce the size of the droplets generated when compared with conventional nozzle devices, as well as reduce the droplet size distributions. In addition, it is an object of the present invention to provide a nozzle arrangement that is adapted to enable small droplets of fluid to be generated at low pressures, i.e. when fluids containing reduced or depleted levels of propellant, or a relatively low-pressure propellant such as compressed gas, is used, or a low-pressure system is used, such as a pump- or trigger-actuated nozzle arrangement.

The problem of providing a high quality spray at low pressures is further exacerbated if the fluid concerned has a high viscosity because it becomes harder to atomise the fluid into sufficiently small droplets.

Accordingly, it is a further object of the present invention to provide a nozzle arrangement that is capable of generating a spray from a viscous fluid at low pressures.

A further problem associated with known nozzle arrangements is that certain products have a tendency to block or clog the spray orifices provided in the nozzle arrangement International Patent Publication Numbers WO 01/89958 and WO 97/31841 both describe cleanable nozzle arrangements, which can be slit apart to expose the internal fluid flow passageway for cleaning. However, it is not practicable to clean the spray orifices after each individual use, which may be necessary with some products that are particularly prone to clogging the nozzle arrangement. As a consequence, the spray orifices present at the outlet of the nozzle arrangement or within the nozzle can become blocked or clogged with such products, which can adversely affect the performance of the nozzle arrangements and thus, the quality of the spray produced.

Hence, it is a further object of the present invention to provide a nozzle arrangement in which the occurrence of blockages at spray orifices is obviated or at least substantially minimised.

In the case of nozzles fitted to pressurised aerosol canisters, there is also a tendency for the fluid flow through the nozzle to reduce as the contents present in the canister become depleted. As previously indicated, this is primarily due to the depletion of the propellant present in the canister and can be particularly undesirable because it results in the quality of the spray produced by the nozzle arrangement being compromised as the canister approaches the end of its operational lifetime.

For this reason, it is a further object of the present invention to means by which the level of fluid flow through a nozzle arrangement can be maintained at a constant or substantially constant level.

According to the present invention there is provided a nozzle arrangement adapted to be fitted to .an outlet of a fluid supply and generate a spray of fluid dispensed from said fluid supply during use, said nozzle arrangement having a body which comprises:
(i) actuator means which is adapted, upon operation, to cause fluid to flow from said fluid supply and through said nozzle arrangement;
(ii) an inlet through which fluid from said fluid supply accesses the nozzle arrangement during use;
(iii) one or more outlet orifices through which fluid is ejected from the nozzle arrangement during use; and
(iv) an internal fluid flow passageway which connects said inlet to said one or more outlet orifices;

wherein said fluid flow passageway further comprises an internal chamber, said chamber having two or more inlet orifices, and an outlet orifice through which fluid may exit the chamber.

The inlet orifices are preferably not directed towards the outlet orifice, so that the fluid will impinge on an internal wall of the chamber. The paths of the fluid from the orifices can be directed either on mutually divergent or mutually convergent paths.

The orifices are preferably outlets from ducts or passages aligned in the direction of the paths, and may lead from a space or chamber downstream of the said internal chamber to the orifices in the latter.

The internal chamber may be configured as a vestibule to the outlet orifice of the nozzle arrangement and have outlet means leading to a plurality of outlet orifices of the nozzle arrangement. Alternatively the outlet from the internal chamber may comprise a single outlet orifice, or a swirl chamber may be provided between the internal chamber and the outlet orifice.

A by-pass passage may be provided which leads from the downstream space or chamber to the internal chamber, and the by-pass passage may feed a plurality of tangential or otherwise aligned inlet orifices into the internal chamber. The flow paths from the by-pass inlet orifices may be arranged to intersect the flow paths from the first mentioned inlet orifices.

A further feed passage may be provided for gaseous medium such as air to be mixed with a liquor phase fluid, direct to the internal chamber. The gaseous medium may be introduced into the internal chamber via a plurality of orifices as a tangential or otherwise directed stream, and the streams may be directed to intersect the paths of fluid entering the internal chamber through the first mentioned inlet orifices.

In another embodiment, liquid phase fluid is fed tangentially to the downstream space and gaseous medium fed direct to the downstream space where they are mixed and then fed to the internal chamber by the ducts or passages from the space to the chamber.

The internal chamber may comprise an expansion chamber and have two or more inlet orifices and two or more outlet orifices, the inlet orifices being arranged in a divergent relationship to one another so that the fluid passing through the internal passageway accesses the chamber through the inlet orifices along independent and divergent paths, and the divergent inlet orifices preferably direct fluid towards the internal walls and/or to corners of the chamber.

The fluid entering the chamber is preferably directed towards an opposing wall of the expansion chamber or a corner between an opposing wall and an opposing wall and an adjacent wall of the expansion chamber.

One or more posts or protrusions may be positioned within the chamber to provide internal wall surfaces towards which the fluid may be directed.

Alternatively, the fluid may be directed towards one or more nodules formed on the internal walls and/or corners of the chamber said nodules being configured to cause further agitation or disturbance to the fluid stream within the chamber.

The outlet orifices may direct fluid exiting the chamber into a continuation of the passageway, and the chamber may be disposed next to the outlet and the outlet orifices of the expansion chamber may constitute outlet orifices of the nozzle arrangement.

The two or more inlet orifices of the internal chamber may be disposed in a convergent relationship to one another so that the fluid stream flowing through the inlet orifices into the chamber are directed toward one another and mix within the chamber.

The nozzle arrangement may, in addition to the said chamber, be configured to provide one or more expansion chambers with aligned inlet and outlet orifices or with a tangential feed, one or more swirl chambers, a chamber having constricted inlet and outlet orifices of lesser diameter from the fluid flow passageway, the latter preferably located between two expansion chambers, a venturi means, and/or a flap valve operative to variably constrict an orifice in response to variation in the pressure of fluid within the passageway, the said further arrangement being provided in any suitable combination.

The fluid supply may be any suitable fluid supply to which a nozzle arrangement is usually attached. In most cases the fluid supply will be container, such as pressurised hand-held aerosol canister.

The nozzle arrangements of the present invention are preferably formed from plastic.

It is also preferable that the body of the nozzle arrangements of the present invention is composed of at least two interconnected parts. Each part preferably has an abutment surface, which may be brought into contact with one another to form the final nozzle arrangement assembly. One or more of the abutment surfaces preferably comprise grooves and recesses formed thereon which, when the surfaces are brought into contact, define the fluid flow passageway (including any chambers positioned along its length), as well as the outlet and, optionally, the inlet. Preferably, a seal is provided between the abutment surfaces, which prevents fluid passing through the nozzle arrangement from leaking out between the abutment surfaces during use. This construction is preferred because it can be manufactured very cheaply and with a high degree of precision. In addition, the constituent parts of the body may be permanently fixed together to form the final, assembled nozzle arrangement or, alternatively, the parts may remain separable so that fluid flow passageway may be opened and exposed for cleaning. Most preferably, the nozzle arrangement is formed of two parts interconnected by a hinge so as to enable the respective parts to be moved towards or away from each other to enable cleaning to be effected.

Preferably, the nozzle arrangement includes one or more internal chambers which are configured to have a width extending transversely of the flow passage and in the plane of the abutment surface of the two parts of the nozzle arrangement, and a depth perpendicular to said plane, which is greater than said width.

The internal chamber preferably has curved interior surfaces defining an elliptical cross-section to said chamber, the major axis of which constitutes the depth. Alternatively, the internal chamber may have planar internal surfaces defining a rectangular or other polygonal cross-section to said chamber.

Advantageously, two or more of the chambers extend in parallel and are provided in independent multiple flow paths of said flow passage.

Nozzle arrangements of this construction are described further in WO 01/89958 and WO 97/31841, the entire contents of which are incorporated herein by reference.

The actuator means may be any suitable actuator means that is capable of initiating the flow of fluid through the nozzle arrangement. Various means are well known in the art. For example, nozzle arrangements fitted to pressurised fluid-filled canisters typically comprise and actuator that can be depressed so as to engage and open the outlet valve of the canister and thereby permit the fluid stored therein to be dispensed through the nozzle arrangement. In addition, pump and trigger nozzle arrangements are widely available as a means for dispensing fluids from non-pressurised containers. In these cases, the operation of the pump or trigger generates the pressure, which causes the fluid from the container to be dispensed through the nozzle arrangement.

How the invention may be put into practice will now be described in more detail in reference to the following Figures, in which:

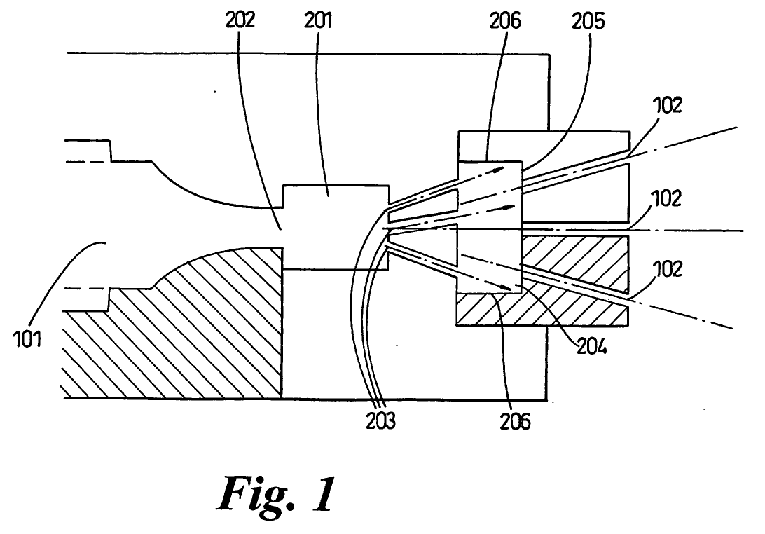

FIG. 1 is a cross-sectional view, in diagrammatic form, taken in a vertical plane through the fluid flow passageway of a nozzle arrangement according to the invention showing the general arrangement thereof;

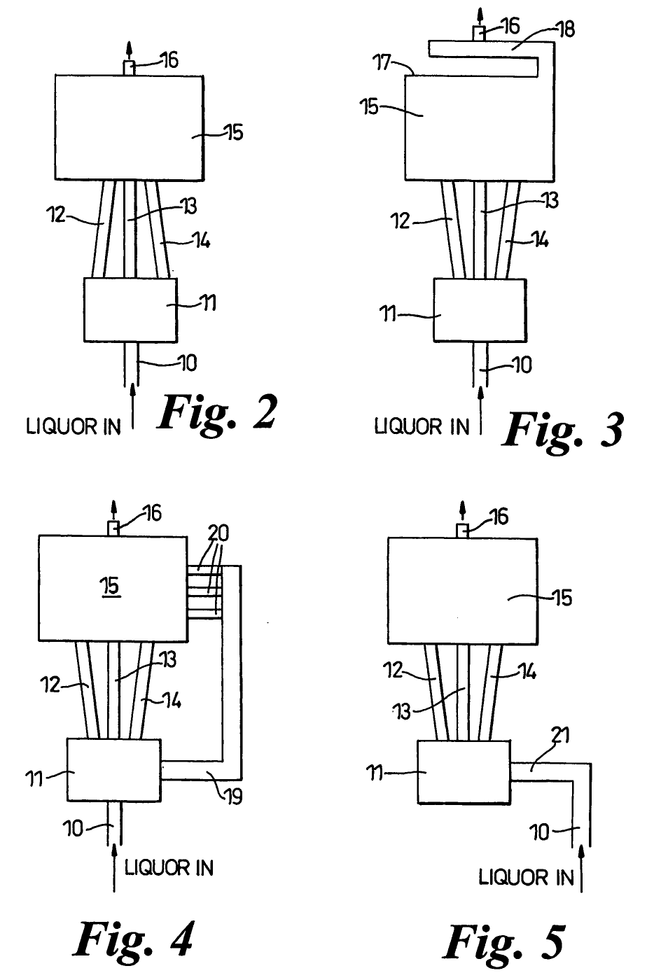

FIG. 2 is a diagrammatic view of part of a flow passageway in a nozzle arrangement according to the invention;

FIG. 3 is a view similar to FIG. 3 of a further embodiment of flow passageway;

FIG. 4 is a similar view of another embodiment of flow passageway;

FIG. 5 is a similar view of a yet further embodiment of flow passageway;

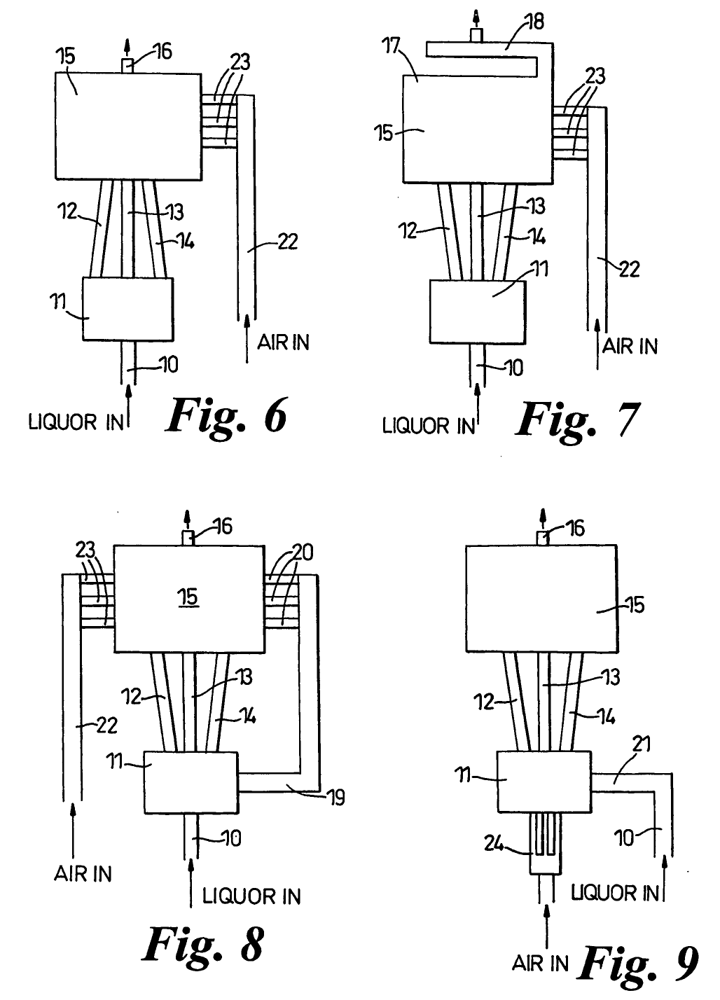

FIGS. 6, 7, 8 and 9 are similar views of flow passageways in nozzle arrangements arranged for both air and liquid feeds; and

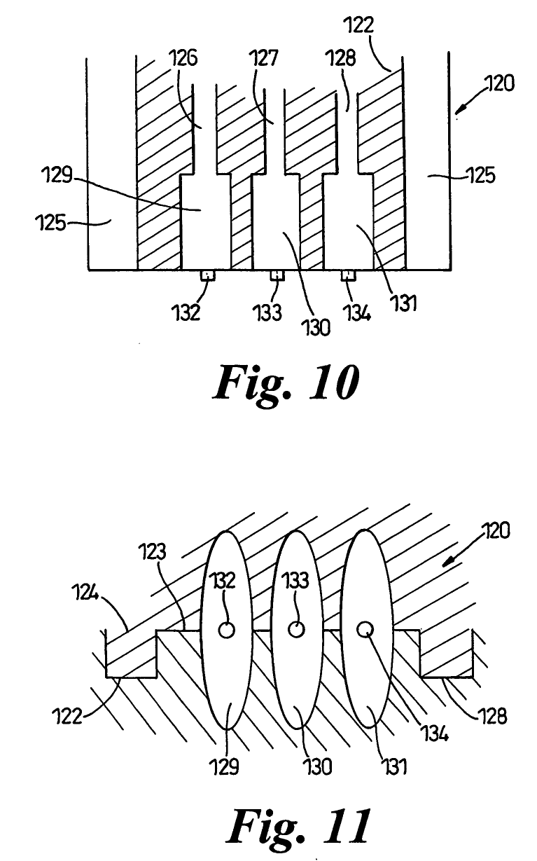

FIG. 10 is a plan view, and FIG. 11 a sectional view of a section of flow passageway showing parallel passages with specially shaped chambers.

FIG. 1 shows a cross-section taken in a horizontal plane through an embodiment of chamber according to the present invention. In FIG. 1 only the outlet portion of the nozzle arrangement is shown, but it will be appreciated that the nozzle arrangement additionally comprises an inlet through which fluid accesses the fluid flow passageway 101 and travels towards the outlet 102. The nozzle arrangement is formed from a base part and an upper part, with the fluid flow passageway 101 and the outlet orifices 102 formed between the abutment surfaces of the upper and lower parts.

During use, the fluid flow passageway 101 feeds fluid into a first chamber 201 through a constricted inlet 202. This causes the fluid to be introduced into the first expansion chamber. Fluid passing through the first expansion chamber travels along a series of divergent orifices 203, which form divergent inlet orifices to a second expansion chamber 204. The second expansion chamber is provided with three outlet orifices 102, through which fluid is ejected from the second chamber and the nozzle arrangement. An important feature of this embodiment resides in the divergent inlet orifices being arranged so that fluid entering the second chamber is directed against the opposing wall 206, or a corner between an opposing wall 206 and an adjacent wall 207, rather than directly towards the outlet orifices 102. The consequence of this arrangement is that fluid is caused to impact on the opposing wall and/or the corner between an opposing wall and the adjacent wall and thereby causes the disruption of the fluid stream and further atomises the droplets contained therein.

FIGS. 2 to 9 of the accompanying drawings are diagrams showing the configurations of a plurality of embodiments of flow passages in nozzle arrangements in accordance with the invention.

FIGS. 2 to 5 show embodiments for use which a single, liquid, phase fluid input to the nozzle, and FIGS. 6 to 9 show embodiments for use with separately fed two phase fluid inputs, one liquid and the other gas, such as air.

FIG. 2 shows a flow passage comprising an inlet conduit 10, a chamber 11 such as an expansion chamber, and three outlets from the chamber 11 which lead to three ducts 12, 13, 14 which converge towards a second chamber 15 to form a convergent input stream with the second chamber 15, which provides a vestibule to an outlet 16 which may be the spray orifice of the nozzle arrangement. The arrangement of converging inlet streams with the second chamber 15 ensures that the streams will converge and impact upon each other, causing disruption of droplets and atomising the liquid to form an even finer spray.

FIG. 3 differs from the FIG. 2 embodiment, in that the ducts 12, 13, 14 leading from first chamber 11 to second chamber 15 diverge from the chamber 11 towards chamber 15, and are disposed so that the jets from the ducts impact upon a wall 17 which faces the outlets of the ducts on the opposite side of the chamber 15 so that the liquid jets impact on the wall, and are atomised by the impact to provide a finer recoil spray back into the chamber 15. The outlet from chamber 15 is asymmetrically disposed and leads to chamber 18, which can be a swirl chamber which acts as a vestibule to the outlet orifice 16.

FIG. 4 is generally similar to FIG. 3, however with the addition of a by-pass providing a side passage 19 leading via multiple orifices 20 and entering the chamber 15 from one side, to impact both on the jets from ducts 12, 13 and 14, and on the opposite side wall of the chamber 15. The orifices 20 may provide a tangential, feed, or a feed perpendicular to the axis of the chamber.

FIG. 5 is similar to FIG. 3, save that the inlet passage 10 is introduced by a section 21 to provide a tangential feed into the first chamber 11.

FIG. 6 is the first embodiment which proposes separate liquid (liquor) and gas (air) feeds to the nozzle arrangement. The function of the air is to assist in the dispersion of liquid droplets and act as a medium to transport them in the spray. The arrangement is similar to FIG. 3, that it comprises an inlet conduit 10 leading to a first chamber 11, having multiple outlets leading to ducts 12, 13, 14 which converge to inlet ports in a second chamber 15, where the jets from the inlet ports converge and impinge on each other within chamber 15. Chamber 15 has an outlet 16 which may provide a discharge outlet for the nozzle arrangement, or lead to further flow passage components.

To the FIG. 2 arrangement, FIG. 6 adds a second parallel inlet conduit 22, connected to an air supply which leads to multiple inlet ports 23 in the side wall of the second chamber 15. Air from the ports 23 impinges on the shattering liquor jets from ducts 12, 13, 14 within the chamber 15 and due to being e.g. tangentially introduced, creates turbulence and a spiral swirl further dividing the droplets and acting as a medium to carry them to and out of the outlet 16.

FIG. 7 shows an embodiment similar to FIG. 3 with divergent ducts 12, 13, 14 between the first chamber 11 and the second chamber 15 and also a swirl chamber 18. Here again a parallel air inlet conduit 22 leads to multiple possibly tangential inlet ports 23 in the side wall of the second chamber 15.

FIG. 8 is similar to FIG. 4, in that it comprises a bypass 19 for liquid medium leading to multiple orifices 20 entering the second chamber 15 from one side. However, as in FIGS. 6 and 7 described above, a separate conduit 22 for air leads to multiple orifices 23 in the side wall of the chamber 15, opposite the liquid orifices 20. The liquid jets from orifices 20 and ducts 12, 13, 14 and the air streams from orifices 23 mutually impact in the interior of chamber 15 and create turbulence and atomisation of the spray and very intimately mix the liquid and air phase to attain maximum spray dispersion.

Finally, FIG. 9 shows an adaptation of the FIG. 6 embodiment. Here, not only is liquor fed via conduit 10 and tangential section 21 in a tangential feed into chamber 11, but also air is fed axially into chamber 11 through a multi-branched nozzle 24, so that intimate air/liquor mixing can take place in the first chamber 11, before entering the divergent ducts 12, 13, 14 leading to the second chamber 15. The liquor and air feeds could be reversed (air via duct 10, liquor via nozzle 24), and chamber 11 may be followed by for example a swirl chamber or an outlet orifice.

It will be appreciated that the flow passageways shown in FIGS. 2 to 9 may be complete passageway arrangements formed in nozzle arrangements according to the invention, or may form only part of such passageways, with other components such as venturis, constrictions, expansion and swirl chambers located either upstream or downstream of the sections shown, or both.

Turning now to the FIGS. 10 and 11, FIG. 1 is a longitudinal and FIG. 12 a vertical cross-section of a further embodiment of the invention. The figures show three expansion chambers forming a section of a flow passage in a nozzle arrangement 120. The nozzle arrangement 120 consists of an upper part 121 and a lower part 122 which an interface 123 defining a plane. The parts 121, 122 are sealed together by means of a rib 124 received in a groove 125. The parts 121, 122 have grooves and depressions therein which together define a flow passageway through the nozzle arrangement 120. In the region of the fragmentary part shown, the flow passageway is subdivided into three parallel independent flow conduits 126, 127 and 128. Each of the conduits enters a respective expansion chamber 129, 130, 131, which also have exits 132, 133, 134 which may if desired be outlets from the nozzle arrangement, or lead directly or indirectly to a re-united passageway, or continue as separate paths to the outlets.

The expansion chambers 129, 130, 131 are remarkable in that they have an elliptical cross-section, with the major axis extending perpendicularly to the plane defined by the interface 123. The expansion chambers could be provided with plane internal surfaces forming rectangular or polygonal chambers. As shown the chambers have considerable elongation on the major axis, e.g. about 5:1 which enable a substantial chamber volume to be attained whilst enabling parallel chambers to be used, which is not possible with conventionally formed chambers because of lack of space.

The chamber design may also be applied to other features such as swirl chambers, and the expansion chambers may be varied from that shown e.g. with tangential inlet feed rather than axial, and be formed with single or multiple throttles.

The chambers may be set in divergent paths or have divergent inlet and outlet orifices, or be offset with respect to each other to create more space for e.g. larger chambers.

The chamber arrangement of FIGS. 10 and 11 may be embodied in a nozzle arrangement such as shown in any of FIGS. 2 to 9, for example being connected into the ducts 12, 13 or 14.

The multiple orifices may lead from a chamber with a tangential feed, which causes the fluid to rotate and spin within the orifice channels, or each orifice could be provided with a respective swirl chamber. The chamber to which they lead may be accessed from the rear, straight from the side, tangentially from the side or any combination thereof. Inlets may face each other across the chamber so that their streams strike each other tangentially, from the same directions or in opposite directions, and in any combinations of single or multiple orifices at different locations.

Additional feeds for air or other gaseous medium may be provided in any embodiment, and this may be fed via a single orifice or multiple orifices and from any surface of the chamber, and in the same or in an opposed direction to the liquid phase medium.

The gas may be fed from parallel, divergent or convergent apertures, and the routes of gas and liquid feeds in FIGS. 6 to 9 may be switched.

The orifices will tend to be from 0.15-0.4 mm in diameter and 0.2-2 mm in length. Smaller diameters such as 0.05 mm diameter may risk blocking. The orifices and passages may be of different diameter.

There may usually be from 2 to 4 orifices but would be as many as 10, and similarly for the air or gas orifices which could however be smaller and in the 0.05-0.2 mm diameter range.

Two separate liquid phase fluids may be introduced in place of the gaseous medium, and the fluid used in singe phase applications may be either liquid or gas.

Whilst the input streams may not impact each other directly if the chamber is flooded, or a tangential feed may result in a vortex around the walls of the chamber so that the stream does not impinge the other feed streams, nevertheless greater turbulence is created inside the chamber which causes greater droplet control in the final sprays.

1. A nozzle arrangement adapted to be fitted to an outlet of a fluid supply and to generate a spray of fluid dispensed from said fluid supply during use, said nozzle arrangement having a body which comprises:
(a) actuator means which is adapted, upon operation to cause fluid to flow from said fluid supply and through said nozzle arrangement;
(b) an inlet through which fluid from said fluid supply accesses the nozzle arrangement during use;
(c) one or more outlet orifices through which fluid is ejected from the nozzle arrangement during use; and
(d) an internal fluid flow passageway which connects said inlet to said one or more outlet orifices;
said fluid flow passageway further comprising an internal chamber, said 15 chamber having two or more inlet orifices, and at least one outlet orifice through which fluid may exit the chamber; and
said chamber has a first plurality of inlet orifices in any one wall thereof, said first plurality of inlet orifices being configured to direct fluid into said internal chamber non-tangentially to said any one wall so that the fluid entering through said first plurality of inlet orifices crosses at least part of the chamber before contacting a wall of the chamber and, where all the inlet orifices enter the chamber from an upstream end, some or all of the inlet orifices direct the fluid accessing the chamber along mutually divergent or mutually convergent paths.

2. A nozzle arrangement according to claim 1, wherein at least two of said first plurality of inlet Orifices are located in different planes perpendicular to the longitudinal axis of the chamber.

3. A nozzle arrangement according to claim 2, wherein said first plurality of inlet orifices enter the chamber through a side thereof.

4. A nozzle arrangement according to claim 3, wherein said first plurality of inlet orifices are configured so as to direct fluid into the chamber along paths that are substantially parallel to one another.

5. A nozzle arrangement according to claim 3, wherein at least some of said first plurality of inlet orifices are configured to direct fluid into the Internal chamber along paths that are mutually convergent or mutually divergent.

6. A nozzle arrangement according to claim 1, wherein said first plurality of inlet orifices enter the chamber from any one side therefore, said nozzle arrangement further comprising one or more additional inlet orifice that enters the chamber from the upstream end or from any side thereof.

7. A nozzle arrangement according to claim 6, wherein said nozzle arrangement comprises more than one additional inlet orifice.

8. A nozzle arrangement according to claim 7, wherein said more than one additional inlet orifices are arranged to direct fluid streams into the chamber along substantially parallel paths.

9. A nozzle arrangement according to claim 7, wherein at least some of said more than one additional inlet orifices are arranged to direct fluid into the chamber along mutually divergent or mutually convergent paths.

10. A nozzle arrangement according to claim 1, wherein the fluid accessing the chamber through at least one of said orifices is directed towards an internal wall of the chamber.

11. A nozzle arrangement according to claim 1, wherein at least some of the inlet orifices into said chamber are outlets from ducts or passages.

12. A nozzle arrangement according to claim 11, wherein said ducts or passages lead from a space or chamber downstream of said chamber to the orifices in said chamber.

13. A nozzle arrangement according to claim 1, wherein said chamber has outlet means comprising a plurality of ducts or passages leading to a plurality of outlet orifices.

14. A nozzle arrangement according to claim 13, wherein the outlet orifices are outlet orifices of the nozzle arrangement.

15. A nozzle arrangement according to claim 13, wherein said plurality of ducts or passages are mutually divergent.

16. A nozzle arrangement according to claim 1, wherein said chamber has outlet means comprising an outlet orifice of the nozzle.

17. A nozzle arrangement according to claim 16, wherein a swirl chamber is connected between said chamber and said outlet orifice.

18. A nozzle arrangement according to claim 1, wherein said first plurality of inlet orifices enter the chamber through one side thereof, said first plurality of inlet orifices being fed from a by-pass passage that leads from said downstream space or chamber to said internal chamber.

19. A nozzle arrangement according to claim 6, wherein said one or more additional inlet orifices direct fluid to intersect the flow paths from said first plurality of inlet orifices.

20. A nozzle arrangement according to claim 6, wherein, in use, said first plurality of inlet orifices are fed with a first fluid and said one or more additional inlet orifices are fed with a second, different fluid.

21. A nozzle arrangement according to claim 20, wherein the different fluids are both liquors.

22. A nozzle arrangement according to claim 20, wherein one fluid is liquor and the other a gas.

23. A nozzle arrangement according to claim 22, wherein the gaseous medium is introduced into said internal chamber via said one or more additional inlet orifices as a tangential or a perpendicular stream.

24. A nozzle arrangement according to claim 22, wherein the streams of gaseous medium entering the internal chamber through said one or more additional inlet orifice is directed to intersect the paths of fluid entering the internal chamber through said first plurality of inlet orifices.

25. A nozzle arrangement according to claim 12, wherein liquor is fed tangentially to the downstream space, and gaseous medium Is fed direct to the downstream space where they are mixed.

26. A nozzle arrangement according to claim 1, wherein the internal chamber comprises an expansion chamber and has two or more inlet orifices and one or more outlet orifice, said inlet orifices being arranged in a divergent relationship to one another so that the fluid passing through the internal passageway accesses the chamber through said inlet orifice or orifices along independent and divergent paths.

27. A nozzle arrangement according to claim 26, wherein said divergent inlet orifices direct fluid towards opposing internal walls and/or corners of the chamber.

28. A nozzle arrangement according to claim 26, wherein the fluid entering the chamber is directed towards an opposing wall of the expansion chamber, or a corner between an opposing wail and an adjacent wall of the expansion chamber.

29. A nozzle arrangement according to claim 26, wherein one or more posts or protrusions are positioned within the chamber to provide internal wall surfaces towards which the fluid may be directed.

30. A nozzle arrangement according to claim 26, wherein the fluid is directed towards one or more nodules formed on the internal walls and/or corners of the chamber, said nodules being configured to cause further agitation or disturbance to the field stream within the chamber.

31. A nozzle arrangement according to claim 1, wherein each of the outlet orifices directs fluid exiting the chamber into a continuation of the passageway.

32. A nozzle arrangement according to claim 26, wherein the chamber is disposed next to the outlet and each of the outlet orifices of the expansion chamber also constitutes an outlet orifice of

33. A nozzle arrangement according to claim 1, wherein the internal chamber has two or more inlet orifices disposed in a convergent relationship to one another so that the fluid streams flowing through the inlet orifices into the chamber are directed toward one another and mix within the chamber.

34. A nozzle a according to claim 1, said internal chamber is configured to have a width extending transversely of the flow passage and a depth perpendicular to said width which is greater than said width.

35. A nozzle arrangement according to claim 34, wherein said internal chamber has curved interior surfaces defining an elliptical cross-section to said chamber the major axis of which constitutes the depth.

36. A nozzle arrangement according to claim 34, wherein said internal chamber has plane interior surfaces defining a rectangular or other polygonal cross-section to said chamber.

37. A nozzle arrangement according to claim 34, wherein two or more of said chambers extend in parallel and are provided in independent multiple flow paths of said flow passage.

38. A nozzle arrangement according to claim 1, wherein, the passageway comprises two or more of said internal chambers.

39. A nozzle arrangement according to claim 38, wherein, said internal chambers are arranged in series or in parallel.

40. A nozzle arrangement adapted to be fitted to an outlet of a fluid supply and to generate a spray of fluid dispensed from said fluid supply during use, said nozzle arrangement having a body which comprises:
(a) actuator means which is adapted, upon operation to cause fluid 20 to flow from said fluid supply and through said nozzle arrangement;
(b) an inlet though which fluid from said fluid supply accesses the nozzle arrangement during use;
(c) one or more outlet orifices through which fluid is ejected from the nozzle arrangement during use; and
(d) an internal fluid flow passageway which connects said inlet to said one or more outlet orifices;
said fluid flow passageway further comprising an internal chamber, said chamber having two or more inlet orifices, and at least one outlet orifice through which fluid may exit the chamber; and
said internal chamber has a plurality of inlet orifices that enter laterally from the side of the chamber, the arrangement being such that where each said lateral inlet orifice is arranged to direct fluid into the chamber tangentially on to the wall of the chamber adjacent the respective inlet orifice, two or more of said lateral inlet orifices are arranged to direct streams of fluid into the chamber in generally opposing circumferential directions.

41. A nozzle arrangement according to claim 40, wherein each of said lateral inlet orifices is arranged to direct fluid into the chamber tangentially on to the wall of the chamber adjacent the respective inlet orifice and two or more of said lateral inlet orifices are arranged to direct fluid into the chamber in generally opposing circumferential

42. A nozzle arrangement as recited in claim 41, wherein said two or more lateral inlet orifices are provided on a common plane perpendicular to the longitudinal axis of the chamber.

43. A nozzle arrangement as recited in claim 41, wherein, at least one of said two or more lateral inlet orifices has a larger cross-sectional area than at least one other of said two or more lateral inlet orifices.

44. A nozzle arrangement as recited in claim 41, wherein there are more than two lateral inlet orifices, at least two of said lateral inlet orifices are arranged to direct streams of fluid in generally opposing circumferential directions.

45. A nozzle arrangement as recited in claim 41, wherein all the lateral inlet orifices are located on a common plane perpendicular to the longitudinal axis of the chamber.

46. A nozzle arrangement as recited in claim 41, wherein some of the lateral inlet orifices are arranged on different planes perpendicular to the longitudinal axis of the chamber so as to be spaced along the chamber.

47. A nozzle arrangement as claimed in claim 46, wherein there are more than two lateral Inlet orifices in each said plane at least two of said lateral inlet orifices in each said plane being arranged to direct streams of fluid into the chamber in generally opposing circumferential directions.

48. A nozzle arrangement according to claim 40, wherein two or more of said lateral inlet orifices are configured to direct fluid in to the chamber non-tangentially, such that the fluid is directed by said at two or more lateral inlet orifices across at least part of the chamber along paths that do not cross each other before they intersect a curved wall portion of the chamber opposite the respective inlet orifices.

49. A nozzle arrangement as claimed in claim 48, wherein at least one of said two or more lateral inlet orifices has a larger cross-sectional area than at least one other of said two or more lateral inlet orifices.

50. A nozzle arrangement as recited in claim 48, wherein at least two of said two or more lateral inlet orifices are arranged in a common plane perpendicular to the longitudinal axis of the chamber.

51. A nozzle arrangement as recited in claim 48, wherein the two or more lateral inlet orifices are configured to direct fluid into the chamber along substantially parallel paths.

52. A nozzle arrangement as recited in claim 48, wherein at least two of said two or more lateral inlet orifices enter from opposite sides of the chamber so as to direct fluid streams across the chamber in generally opposing lateral directions.

53. A nozzle arrangement as recited in claim 48, wherein at least two of said two or more lateral inlet orifices enter from the same side of the chamber so as to direct fluid streams across the chamber in the same general lateral direction.

54. A nozzle arrangement as recited in claim 40, wherein the chamber has a single outlet orifice.

55. A nozzle arrangement as claimed in claim 54, wherein the outlet orifice is located centrally in a downstream end of the chamber.

56. A nozzle arrangement as recited in claim 40, wherein the chamber has more than one outlet orifice.

57. A nozzle arrangement as recited in claim 40, wherein each of the outlet orifices from the chamber comprises an outlet or final spray orifice of the nozzle arrangement.

58. A nozzle arrangement as recited in claim 40, wherein each one of the outlet orifices from the chamber directs fluid exiting the chamber into a continuation of the nozzle arrangement upstream from the final outlet orifice or orifices of the nozzle arrangement.

59. A nozzle arrangement as claimed in claim 58, wherein a swirl chamber is provided in the continuation of the nozzle arrangement prior to the final outlet orifice or orifices of the nozzle arrangement.

60. A nozzle arrangement as recited in claim 40, wherein the chamber has a circular cross-section.

61. A nozzle arrangement as recited in claim 40, wherein the chamber has a non-circular cross section.

62. A nozzle arrangement as recited in claim 40, wherein one or more additional fluid inlet orifices enter the chamber from an upstream end thereof.

63. A nozzle arrangement as claimed in claim 62, wherein said one or more additional inlet orifices are configured to direct fluid longitudinally into the chamber.

64. A nozzle arrangement as recited in claim 40, wherein all the inlet orifices are arranged to feed a single liquor into the chamber from the fluid source.

65. A nozzle arrangement as recited in claim 63, wherein the additional inlet orifices are arranged to feed a gas such as air, into the chamber while the lateral inlet orifices are adapted to feed a liquor into the chamber.

66. A nozzle arrangement according to claim 7, wherein said one or more additional inlet orifices direct fluid to intersect the flow paths from said first plurality of inlet orifices.

67. A nozzle arrangement according to claim 8, wherein said one or more additional inlet orifices direct fluid to intersect the flow paths from said first plurality of inlet orifices.

68. A nozzle arrangement according to claim 9, wherein said one or more additional inlet orifices direct fluid to intersect the flow paths from said first plurality of inlet orifices.

69. A nozzle arrangement according to claim 7, wherein, in use, said first plurality of inlet orifices are fed with a first fluid and said one or more additional inlet orifices are fed with a second, different fluid.

70. A nozzle arrangement according to claim 8, wherein, in use, said first plurality of inlet orifices are fed with a first fluid and said one or more additional inlet orifices are fed with a second, different fluid.

71. A nozzle arrangement according to claim 9, wherein, in use, said first plurality of inlet orifices are fed with a first fluid and said one or more additional inlet

72. A nozzle arrangement according to claim 27, wherein the fluid is directed towards one or more nodules formed on the internal walls and/or corners of the chamber, said nodules being configured to cause further agitation or disturbance to the field stream within the chamber.

73. A nozzle arrangement according to claim 28, wherein the fluid is directed towards one or more nodules formed on the internal walls and/or corners of the chamber, said nodules being configured to cause further agitation or disturbance to the field stream within the chamber.

74. A nozzle arrangement according to claim 29, wherein the fluid is directed towards one or more nodules formed on the internal walls and/or corners of the chamber, said nodules being configured to cause further agitation or disturbance to the field stream within the chamber.

75. A nozzle arrangement according to claim 27, wherein the chamber is disposed next to the outlet and each of the outlet orifices of the expansion chamber also constitutes an outlet orifice of the nozzle arrangement.

76. A nozzle arrangement according to claim 28, wherein the chamber is disposed next to the outlet and each of the outlet orifices of the expansion chamber also constitutes an outlet orifice of the nozzle arrangement.

77. A nozzle arrangement according to claim 29, wherein the chamber is disposed next to the outlet and each of the outlet orifices of the expansion chamber also constitutes an outlet orifice of the nozzle arrangement.

78. A nozzle arrangement according to claim 30, wherein the chamber is disposed next to the outlet and each of the outlet orifices of the expansion chamber also constitutes an outlet orifice of the nozzle arrangement.

79. A nozzle arrangement according to claim 31, wherein the chamber is disposed next to the outlet and each of the outlet orifices of the expansion chamber also constitutes an outlet orifice of the nozzle arrangement.

80. A nozzle arrangement as recited in claim 42, wherein at least one of said two or more lateral inlet orifices has a larger cross-sectional area than at least one other of said two or more lateral inlet orifices.

81. A nozzle arrangement as recited in claim 42, wherein there are more than two lateral inlet orifices, at least two of said lateral inlet orifices are arranged to direct streams of fluid in generally opposing circumferential directions.

82. A nozzle arrangement as recited in claim 43, wherein there are more than two lateral inlet orifices, at least two of said lateral inlet orifices are arranged to direct streams of fluid in generally opposing circumferential directions.

83. A nozzle arrangement as recited in claim 42, wherein all the lateral inlet orifices are located on a common plane perpendicular to the longitudinal axis of the chamber.

84. A nozzle arrangement as recited in claim 43, wherein all the lateral inlet orifices are located on a common plane perpendicular to the longitudinal axis of the chamber.

85. A nozzle arrangement as recited in claim 42, wherein some of the lateral inlet orifices are arranged on different planes perpendicular to the longitudinal axis of the chamber so as to be spaced along the chamber.

86. A nozzle arrangement as recited in claim 43, wherein some of the lateral inlet orifices are arranged on different planes perpendicular to the longitudinal axis of the chamber so as to be spaced along the chamber.

87. A nozzle arrangement as recited in claim 49, wherein at least two of said two or more lateral inlet orifices are arranged in a common plane perpendicular to the longitudinal axis of the chamber.

88. A nozzle arrangement as recited in claim 49, wherein the two or more lateral inlet orifices are configured to direct fluid into the chamber along substantially parallel paths.

89. A nozzle arrangement as recited in claim 50, wherein the two or more lateral inlet orifices are configured to direct fluid into the chamber along substantially parallel paths.

90. A nozzle arrangement according to claim 14 in which said plurality of ducts or passages are mutually divergent.

91. A nozzle arrangement as recited in claim 49, wherein at least two of said two or more lateral inlet orifices enter from opposite sides of the chamber so as to direct fluid streams across the chamber in generally opposing lateral directions.

92. A nozzle arrangement as recited in claim 50, wherein at least two of said two or more lateral inlet orifices enter from opposite sides of the chamber so as to direct fluid streams across the chamber in generally opposing lateral directions.

93. A nozzle arrangement as recited in claim 51, wherein at least two of said two or more lateral inlet orifices enter from opposite sides of the chamber so as to direct fluid streams across the chamber in generally opposing lateral directions.

94. A nozzle arrangement as recited in claim 49, enter from the same side of the chamber so as to direct fluid streams across the chamber in the same general lateral direction.

95. A nozzle arrangement as recited in claim 50, wherein at least two of said two or more lateral inlet orifices enter from the same side of the chamber so as to direct fluid streams across the chamber in the same general lateral direction.

96. A nozzle arrangement as recited in claim 51, wherein at least two of said two or more lateral inlet orifices enter from the same side of the chamber so as to direct fluid streams across the chamber in the same general lateral direction.
